(19) United States
(12) Patent Application Publication
(10) Pub. No.: US 2005/0259923 A1
(43) Pub. Date: Nov. 24, 2005

(54) Optical coupler

(76) Inventors: Sriram S. Sriram, Powell, OH (US); Anand Gopinath, Wayzata, MN (US); Ross Schermer, Alexandria, VA (US); John Marsh, Utica, NY (US)

Correspondence Address: Judson K. Champlin;Westman, Champlin & Kelly, Suite 1600, 900 Second Avenue South, Minneapolis, MN, 55402-3319, US

(21) Appl. No.: 11/096,250

(22) Filed: Mar. 31, 2005

Related U.S. Application Data
(63) Continuation-in-part of application No. 10/850,358, filed on May 20, 2004.
(60) Provisional application No. 60/557,989, filed on Mar. 31, 2004.
(60) Provisional application No. 60/472,018, filed on May 20, 2003.

(51) Int. Cl. G02B 6/26

(52) U.S. Cl. 385/50

(57) ABSTRACT

An optical coupler includes a substrate and first and second elongate optical waveguides on the substrate. A structure extends along the waveguides and is configured to provide variable coupling between the waveguides. The coupler can be formed in Lithium Niobate.

### BACKGROUND OF THE INVENTION

The present application is based on and claims the benefit of U.S. provisional patent application Ser. No. 60/557,989, filed Mar. 31, 2004, the content of which is hereby incorporated by reference in its entirety, the present invention is also a Continuation-In-Part of U.S. Ser. No. 10/850,358, filed May 20, 2004 which is based on and claims the benefit of U.S. provisional patent application Ser. No. 60/472,018, filed May 20, 2003, both of which are hereby incorporated by reference as if completely rewritten herein.

The present invention relates to optical devices. More specifically, the present invention relates to optical couplers.

Optical devices are finding increasingly widespread use in various fields such as communications, data processing, storage, and other technologies. In some cases, optical components are completely supplanting the equivalent electrical components. In other situations, components are manufactured which have both electrical and optical characteristics for use in hybrid technologies.

In many instances, optical components perform functions which are similar to their electrical equivalents. For example, optical couplers are used to allow more than one optical signal to interact with each other or in some way provide an interrelationship between the two signals. One type of optical coupler uses two waveguides which are run parallel to each other. Each waveguide is configured for coupling to separate optical fibers. As optical signals are passed from the optical fibers to the waveguides, the signals propagate along the waveguides. Due to the close proximity and optical characteristics of the waveguides, interaction between the two signals occurs. For example, one signal can be used to modulate an optical signal in the other fiber, one signal can be used to induce an optical signal in another fiber, etc. However, in many instances, optical couplers have undesirable optical characteristics which cannot be easily controlled.

### SUMMARY OF THE INVENTION

An optical coupler includes a substrate and first and second elongate optical waveguides on the substrate. A structure extends along the waveguides and is configured to provide variable coupling between the waveguides. The coupler can be formed in Lithium Niobate.

### BRIEF DESCRIPTION OF THE DRAWINGS

FIG. 1 is a schematic diagram of an optical coupler modulator.

FIG. 2 is a perspective view of one example embodiment of an optical coupler of coupler modulator.

FIG. 3 is a graph of normalized intensity response versus normalized bias for an optical coupler calculated using coupled mode theory.

FIG. 4A is a graph of the coupling function versus distance along a coupler obtained using a Fourier transform method.

FIG. 4B is a graph of amplitude response versus normalized bias.

FIG. 5 is a schematic diagram of a variable spacing optical coupler. λ/2 phase shift sections can be placed in the top arm where the spacing increases to achieve substantially zero coupling.

FIG. 6 is a schematic diagram of a parallel guide optical modulator having curved sections to provide phase changes.

FIG. 7 is a cross-sectional view of a optical coupler having a ridge guide configuration and a stepped trench therebetween.

FIG. 8 is a graph showing the response of a stepped etched ridge guide structure in accordance with FIG. 7 versus applied voltage.

FIG. 9A is a graph of the normalized coupling coefficient versus normalized distance for initial coupling function obtained using a Fourier transform method and a final coupling function obtained using an iterative Newtons method. FIG. 9B is a graph of a real part of a response versus normalized frequency and FIG. 9C is a graph of the imaginary part of the response versus normalized frequency for a dispersion compensator using the final coupling function.

FIG. 10 is a graph of intensity versus modulator drive voltage for a desired trapezoidal response function which provides a substantially constant modulator response and a steep response at the switching voltage.

FIG. 11 is a perspective view of a optical coupler using ridge waveguides which includes a third ridge to provide variable coupling.

FIG. 12 is a cross-sectional view of an optical coupler including a third waveguide formed using diffused material.

FIG. 13a is a schematic representation of a conventional directional coupler modulator.

FIG. 13b is a cross sectional view of the directional coupler modulator shown in FIG. 13a taken at line 13b-13b.

FIG. 14 is a graphical illustration of the ideal response function for a linearized modulator.

FIG. 15a is a trace of a modulator coupling function.

FIG. 15b is a trace of a modulator desired response function.

FIG. 16 is a schematic representation of a variable coupling directional coupler according to the present invention.

FIG. 17a is an output diagram of a beam propagation method simulation in which light enters on the left and transfers energy back and forth between the two waveguide channels. The coupling length is 9.2 mm.

FIG. 17b is an output diagram of a beam propagation method simulation illustrating a baseline coupler. The coupling length is 13.0 mm.

FIG. 17c is an output diagram of a beam propagation method simulation illustrating a 17 mm coupling length with a raised index to increase the coupling coefficient.

FIG. 18 is a schematic representation of a directional coupler modulator according to embodiments of the present invention.

FIG. 19a is a schematic illustration of a periodic segmented waveguide structure in which a sudden increase in effective index of the waveguide is achieved.

FIG. 19b is a schematic illustration of a periodic segmented waveguide structure in which a gradual increase in effective index is achieved.

FIG. 19c is a schematic illustration of a periodic segmented waveguide structure in which a gradual increase in effective index is achieved along with additional mode expansion in the horizontal plane.

FIGS. 20 a-f are simulation plots that illustrate the benefit of using periodic segmented waveguide structures to improve the coupling efficiency between two waveguides. FIG. 20a illustrates an abrupt junction between two step-index waveguides while FIG. 20d shows a periodic segmented waveguide structure. FIGS. 20b and 20e are the optical field patterns while FIGS. 20c and 20f are at 10×magnification.

FIG. 21 is a schematic illustration of a directional coupler modulator in accordance with embodiments of the invention.

### DETAILED DESCRIPTION OF THE PREFERRED EMBODIMENTS

Optical co-directional couplers have been used in a variety of applications, including 2×2 switches, 3 dB splitters, modulators, filters, and also in combination with other devices. In most of these instances, these couplers have had constant coupling. However, in Titanium-Diffused Lithium Niobate Waveguide Devices, in Guided Waveguide Devices second edition, pp. 145-210, 1988), Alferness describes variable coupling, which is implemented using weighted coupling filters. The present invention is related to variable coupling in optical couplers. Coupling engineering concept and appropriate synthesis techniques may by used to design directional couplers as modulators with specified response function, for example filters with specific amplitude and phase response, switches with specific switching voltages, dispersion compensators with specified amplitude and phase response, among other applications. In general, the synthesis methods for the variable coupling coupler for these and other applications lead to complex coupling functions for amplitude and phase, the realization of which proves to be difficult. However, with careful formulation, the synthesis yields coupling functions that have only positive and negative coupling components. This change of sign may be implemented by introducing an extra half-wavelength at the center wavelength on one side of the coupler arms at the appropriate point to obtain the required 180° phase shift, to change the sign of the coupling function. The present invention can be used to implement other components such as those listed above.

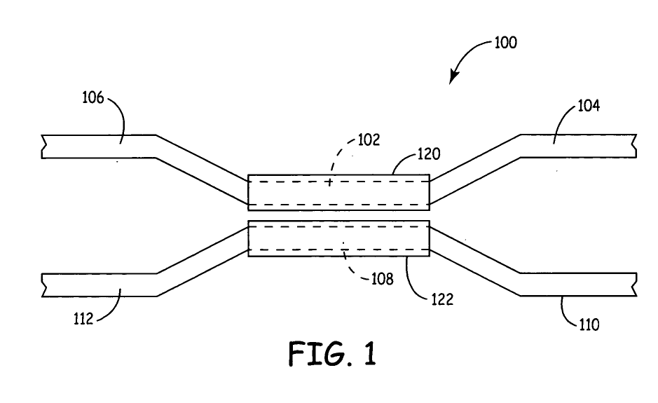

FIG. 1 is a simplified schematic diagram of an optical coupler 100 having a first waveguide 102 coupled to waveguides 104 and 106, and a second waveguide 108 coupled to waveguides 110 and 112. Waveguides 102 and 108 are shown as extending in a parallel direction and are aligned in a single plane. A hot electrode 120 overlays waveguide 102 and a ground electrode 122 overlays waveguide 108.

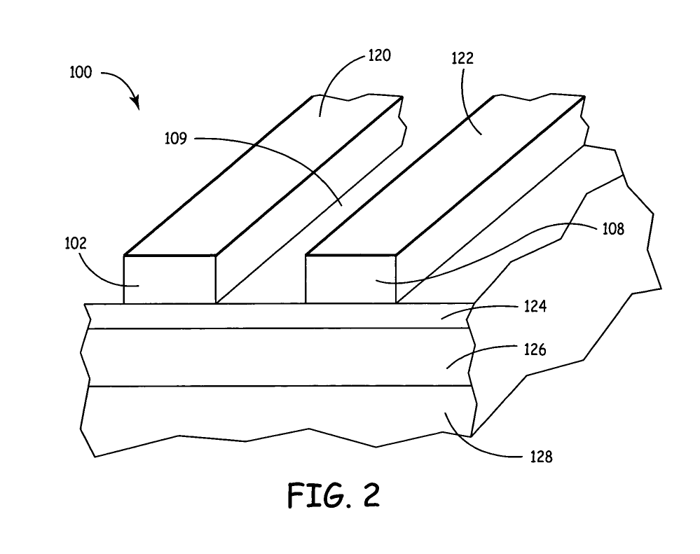

FIG. 2 is a perspective view of coupler 100 which depicts electrodes 120 and 122 overlaying waveguides 102 and 108, respectively. In FIG. 2, waveguides 102 and 108 are illustrated as ridge waveguides. The trench 109 between the waveguides 102 and 108 is shown as having a constant height. Electrodes 120 and 122 are carried on cladding layer 124 which overlies a guide layer 126. The entire-structure is supported on a substrate 128. The present invention is related to providing variable coupling between the two waveguides 102 and 108 illustrated in FIG. 1.

Optical modulators are used to modulate optical signals. External optical modulators are typically used in fiber optical systems since direct modulation of lasers leads to spectral broadening. Optical modulators may take different forms, and these include the electro-optic modulators which use the linear electro-optic effect or the Pockel's effect, the electro-absorption modulators which may utilize the quantum confined Stark effect or the Franz-Keldysh effect. (See for example, N. Dagli, Wide-bandwidth lasers and modulators for RF photonics, IEEE Transactions on Microwave Theory & Techniques, vol. 47, pp. 1157-1171, 1999 and R. B. Welstand, J. T. Zhu, W. X. Chen, A. R. Clawson, P. K. L. Yu, and S. A. Pappert, “Combined Franz-Keldysh and Quantum-Confined Stark Effect Waveguide Modulator for Analog Signal Transmission,” Journal of Lightwave Technology, Vol. 17, pp. 497-502, 1999.) The most commonly used device is the Mach-Zehnder interferometer using the Pockel's effect in lithium niobate (See for example, N. Dagli, Wide-bandwidth lasers and modulators for RF photonics, IEEE Transactions on Microwave Theory & Techniques, vol. 47, pp. 1157-1171, 1999 and R. Alfterness, Titanium-Diffused Lithium Niobate Waveguide Devices, in Guided Wave Optoelectronics, Editor: T. Tamir, Springer-Verlag, second edition, pp. 145-210, 1988). The Stark effect electro-absorption modulator may be integrated with the laser source with careful epitaxial growth techniques.

The Mach-Zehnder interferometer in lithium niobate is widely used particularly for long haul applications where the chirp performance is very important. The chirp generated in these devices is negligible and may also be deliberately introduced, and the optical insertion loss is in the 5 to 7 dB range. These devices, with velocity matched traveling wave electrode structures for frequency response to the 40 Gbps range, have switching voltages of the order of 4 V to 10 V. The intensity response function of the modulated signal with linear voltage drive is of the form [1+COS(πV_{drive/}V_{drive/}V_{π})]². (See for example, R. Alfterness, Titanium-Diffused Lithium Niobate Waveguide Devices, in Guided Wave Optoelectronics, Editor: T. Tamir, Springer-Verlag, second edition, pp. 145-210, 1988). While most of these modulators are based on LiNiBO₃, a body of work also exists on III-V semiconductor based devices. (See for example, R. G. Walker, High speed III-V semiconductor intensity modulators, IEEE J. Quantum. Electronics, vol. 27, pp. 654-667, 1991). The coupler modulator is an alternative electro-optic modulator, both in lithium niobate and semiconductor material. (See for example, J. P. Donnelly, A. Gopinath: A comparison of power requirements of traveling-wave LiBn03 optical couplers and interferometric modulators, IEEE J. Quantum Electron, Vol. QE-23, pp. 30-41, 1987 and M. Nisa Khan, Wei Yang, Anand Gopinath, Directional coupler electrooptic modulator in Al-GaAS/GaAs with low voltage-length product, Appl. Phy. Lett., Vol 62, pp. 2033-2035, 1993).

The present invention includes a variable coupling co-directional coupler modulator using the linear electro-optical effect, in which the design of the modulator structure is synthesized to obtain a desired response function. The attraction of this device is that in principle any response function, amplitude and phase may be obtained from the synthesized design.

Referring back to FIGS. 1 and 2, a standard coupler modulator such as modulator 100 has two identical optical waveguides 102 and 108 placed in close proximity to each other so that the gap between them is a constant. Gap distances can range from 1 to 30 μm. The coupled waveguides are designed to support only two super modes at the wavelength of operation, one odd and the other even. Analysis of these supermodes indicates that these odd and even modes have different velocities. Excitation of an optical signal on one of the guides is in fact the excitation of the superposition of both these modes, so that they add constructively on the excited guide, and add destructively in the other guide. The modes travel at different velocities as they move down the guides, and the phase relationship changes so that at some distance downstream, the modes interfere constructively in the second guide but add destructively in the excited guide. This distance is defined as the coupling length of the coupler. Placing this device of one coupling length in linear electro-optic effect material allows the index of the individual guides to be altered, to increase and decrease their indices by means of electric fields generated using electrodes 120 and 122. This effectively decreases the coupling length and changes the power transfer, since the guides are no longer identical, so that the light in the excited guide emerges from it at the end of the coupler. FIG. 1 shows a schematic diagram of this device 100 with a constant gap, and hence constant coupling, and FIG. 2 shows a perspective of a ridge waveguide implementation.

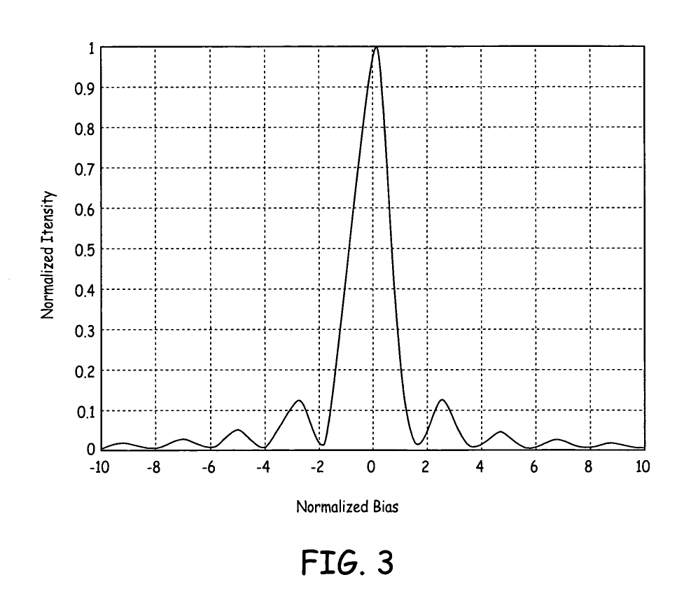

The electro-optic coupler shown in FIGS. 1 and 2 with bias can act as a switch, or a modulator. It can be shown that a constant gap and the resultant constant coupling results in the sinc response function for the signal against bias, shown in FIG. 3. This sinc² intensity response can be seen as following a sinc² function and is a highly nonlinear response.

Recent theoretical work has shown that the grating assisted contra-directional coupler filters may be synthesized by two methods, the first, using the inverse scattering technique based on the theory of Gel'fand, Levitan, and Marchenko, i.e., the “GLM” method, (See for example, G.-H. Song, S. Y. Shin, Design of corrugated waveguide filters by the Gel'fand-Levitan-Marchenko inverse scattering method, J. Opt. Soc. Am. A, vol. 2, pp. 1905-1915, 1985), which requires that the response function be expressed as a rational polynomial. This has resulted in modulator designs based on the usual Butterworth, Chebyschev designs, which are both polynomial functions widely used in electrical filter designs. Recent work by Peral (See for example, Eva Peral, Jose Capmany and Javier Marti “Iterative Solution to the Gel-Fand-Levitan-Marchenko Coupled Equations and Application to Synthesis of Fiber Gratings”, IEEE J. Quantum Electronics, Vol. 32 pp. 2078-2084, 1996) has shown an iterative scheme that may be used with the GLM method to circumvents the need to express the desired response as a rational polynomial. The second synthesis method is the Fourier transform method (See for example, K. Winick, Design of corrugated waveguide filters by Fourier transform techniques, IEEE J. Quantum. Electronics, vol. 26, pp. 1918-1929, 1990), which is discussed by Alferness in Tamir's book (See R. Alfterness, Titanium-Diffused Lithium Niobate Waveguide Devices, in Guided Wave Optoelectronics, Editor: T. Tamir, Springer-Verlag, second edition, pp. 145-210, 1988) which assumes that the coupling is very small, and thus the method is at best approximate. A detailed design with the Fourier method for a grating coupled filter is discussed in K. Winick, Design of corrugated waveguide filters by Fourier transform techniques, IEEE J. Quantum. Electronics, vol. 26, pp. 1918-1929, 1990) for a grating coupled filter. Thus, the methodology used in these designs has been discussed in the open literature since the 1970s.

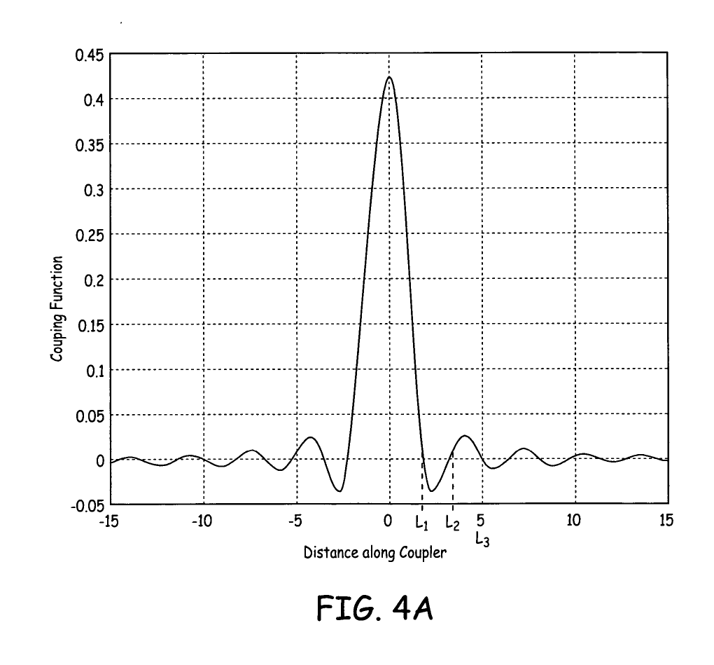

The application of this methodology to suitably modified co-directional coupler modulator, has only recently been performed. (See for example, S. W. Løvseth, Optical directional couplers using the linear electro-optic effect for use as modulators and filters, Dipl. Engineer thesis, Physics Department, Norwegian University of Science and Technology, May 20, 1996; S. W. Løvseth, C. Laliew, A. Gopinath, Amplitude response of optical directional coupler modulator by the Fourier transform technique, Proceedings of the 8^{th} European Conference on Integrated Optics, pp. 230-233, April 1997; S. W. Løvseth, C. Laliew, A. Gopinath, Synthesis of amplitude response of optical directional coupler modulators, 1997 IEEE-MTT-S International Microwave Symposium digest, vol III, pp. 1717-1720, June 1997; Anand Gopinath, Chanin Laliew, Sigurd Løvseth, Synthesis of the of optical modulator re-sponse, IEEE International Topical Meeting on Microwave-Photonics Technical Digest, paper MC-4, pp. 41-43, 12-14 Oct. 1998, Princeton, N.J. (Invited Talk); Chanin Laliew, Xiaobo Zhang, Anand Gopinath, Linearized optical directional modulator, Integrated Photonics Research Meeting, July 1999, Santa Barbara, Calif.; C. Laliew, X. Zhang, A. Gopinath, Linearized optical directional-coupler modulators for analog Rf/Microwave transmission systems, IEEE MTT-S International Microwave Symposium, pp. 1829-1832, Boston, Mass., June 2000; T. Li, C. Laliew, A. Gopinath, An iterative transfer matrix inverse scattering technique for synthesis of co-directional couplers and filters, IEEEJ. Quantum Electronics, vol. 38, pp. 375-379, April 2002. For a specified output response function, usually expressed in terms of output light intensity, the coupling between the guides needs to be determined so that this response is generated. In the above papers (see S. W. Løvseth, C. Laliew, A. Gopinath, Amplitude response of optical directional coupler modulator by the Fourier transform technique, Proceedings of the 8^{th} European Conference on Integrated Optics, pp. 230-233, April 1997; S. W. Løvseth, C. Laliew, A. Gopinath, Synthesis of amplitude response of optical directional coupler modulators, 1997 IEEE-MTT-S International Microwave Symposium digest, vol III, pp. 1717-1720, June 1997) it has been shown that both the GLM method and the Fourier transform technique may be used to obtain the coupling function. Recent experimental work has shown that the Fourier method yields designs when fabricated show response functions close to the specified functions (see for example, T. Li, C. Laliew, A. Gopinath, An iterative transfer matrix inverse scattering technique for synthesis of co-directional couplers and filters, IEEEJ. Quantum Electronics, vol. 38, pp. 375-379, April 2002; C. Laliew, S. Løvseth, X. Zhang, A. Gopinath: Linear optical coupler modulators, J. Light-wave Tech., Vol. 18, pp. 1244-1249, 2000). In these experiments, the coupling function was obtained by performing the Fourier transform of the square root of the intensity response, since the coupling function and the output field response are Fourier transform pairs. The conversion of this coupling function to the actual device design requires additional steps. A typical linear response function triangular shaped results in the coupling function shown in FIG. 4A. FIG. 4B shows the response function which is obtained with this coupling function truncated with three lobes on each side, which is different from the original desired linear response function. Note also that the Fourier transform coupling function does not reach unity on a normalized scale.

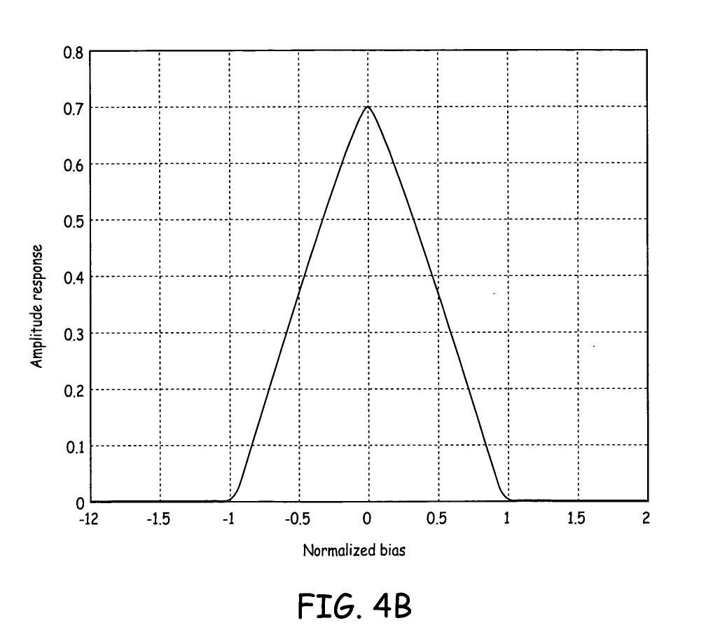

One design of the variable coupling directional coupler modulator was realized in III-V semi-conductor material, GaAs/AlGaAs, designed to operate at 1300 nm wavelength, and designed to have a linear response of the form shown in FIG. 4 (See C. Laliew, S. Løvseth, X. Zhang, A. Gopinath: Linear optical coupler modulators, J. Light-waveTech., Vol. 18, pp. 1244-1249, 2000. The major innovation of this design was the realization of a negative coupling function by providing a phase shift of 180°. The phase shift was achieved using an increased length in one of the arms of the coupler. FIG. 5 is a schematic diagram of the variable spacing modulator, with λ/2 phase shift sections in the top arm when the spacing increases for almost zero coupling. (See for example, C. Laliew, S. Løvseth, X. Zhang, A. Gopinath: Linear optical coupler modulators, J. Light-wave Tech., Vol. 18, pp. 1244-1249, 2000). In coupler 200 shown in FIG. 5, the variation of the coupling function is obtained by varying the spacing between the guides 202 and 204. A problem with this approach is that the switching voltage (or the vπ) becomes large, and therefore the device is useful only when low modulation depths are required. In one experiment the switching voltage was estimated at 48 V, and only the 0 V to 12 V was used to evaluate the linearity, because the material broke down when the voltage increased beyond 17 V.

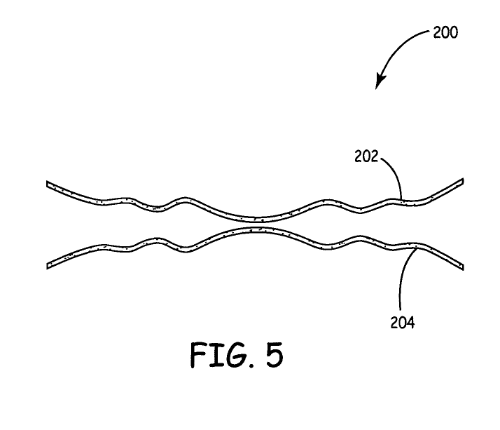

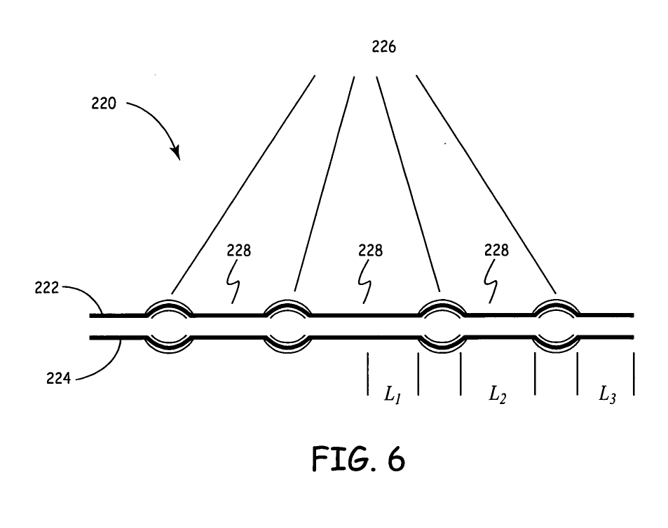

A coupler 220 illustrated in FIG. 6 in accordance with the present invention uses straight parallel waveguides 222 and 224, which are partitioned to add curved sections 226 between the partitions 228. These curved sections 226 increase the gap between the waveguides to have almost zero coupling. A 180° phase shift length (on the order of 0.2 μm in semiconductors) is included in one of the sides of the curved sections. This extra length is too small to appear in the Figure. L₁, L₂, and L₃ are distances illustrated in FIG. 4A. Here coupling variations are obtained by means of etching steps between the guides in steps as shown in FIG. 7. The highest step can be at L₁, next at L₂ and lowest or deepest step at L₃. FIG. 7 is a cross-sectional view of the coupler 220 shown in FIG. 6. Coupler 220 includes electrodes 230 and 232 which overly ridge waveguides 222 and 224, respectively. In the cross-sectional view, two steps, step 240 and 242, are visible in the upper cladding layer 250. The cladding layer 250 is deposited on guide layer 252 carried on substrate 254. The steps 240, 242 can be formed using any appropriate technique for the selected material. Referring back to FIG. 6, a step should be positioned at L₁, L₂ and L₃. Steps 242 and 240 provide a trench which extends between the two optical waveguides 222 and 224. The trench provides variable coupling between the two waveguides 222 and 224. The variations in the trench depth may be either stepped or continuous. The depth may be continuously variable across any desired length.

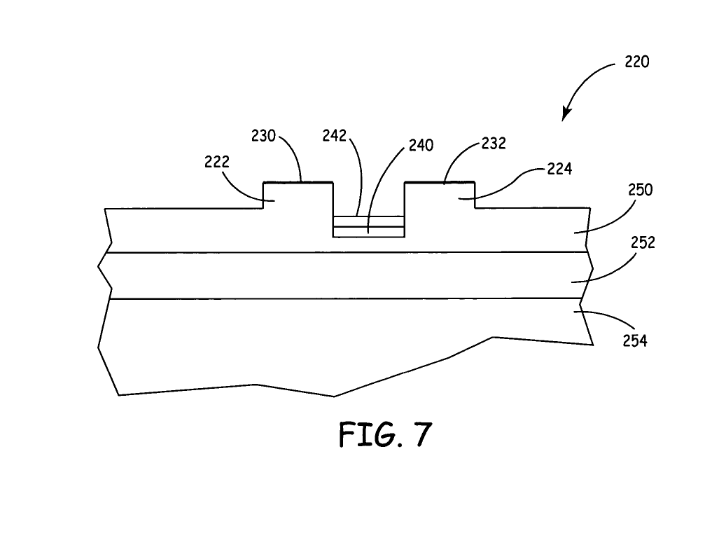

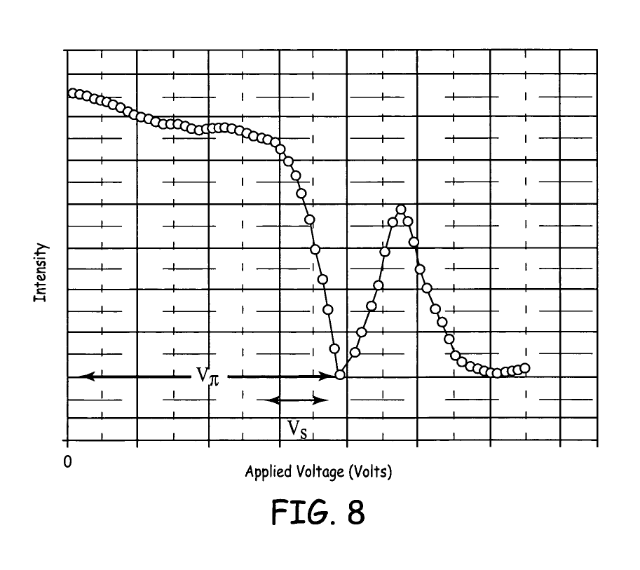

Using the embodiments of FIGS. 6 and 7, a resulting response is shown in FIG. 8 which is a graph of intensity of light through the device versus applied voltage. In this case, the response obtained is in the form of a half-trapezoid with additional side lobes. This response is fairly close to the predicted response. Thus, it is possible to realizes the designs, implement the required phase shift to obtain negative coupling, and build modulators which behave as predicted in semiconductor material.

Co-directional couples can be used as filters. Variable coupling optical couplers with no change in coupling sign, the so called weighted coupler discussed by Alferness (see Titanium-Diffused Lithium Niobate Waveguide Devices, in Guided Wave Optoelectronics, Editor: T. Tamir, Springer-Verlag, second edition, pp. 145-210, 1988), have shown reasonable filtering capabilities. These configurations have used exponential and other forms of coupling variation, typically with the one straight guide and a second guide with a decreasing spacing having a form of one of these functions to a minimum, and then symmetrically increasing the spacing. Although these filters also use the Fourier method. The filters are not narrow band.

A second type of filters use vertical couplers. Vertical couplers are designed with guides stacked above each other with a spacer between them. The guides are of different widths, so as to have different mode velocities, and phased matched at a single wavelength (See for example, S.-K. Han, R. V. Ramaswamy, R. F. Tavlykaev, Narrow band vertically stacked filters in InGaAlAs/InP at 1.5 ¹m, Journal of lightwave Tech., vol. 14, no. 1, pp. 77-83, 1996). With the rapid fall of phase match at a particular wavelength, the transfer characteristics are frequency dependent and result in a filtering response. The filters are relatively narrow band, demonstrated to be of the order of 18 Å, which are adequate for widely spaced WDM (wavelength division multiplexing) channels but inadequate for dense WDM, with 100 GHz spacing. The use of gratings in one of the guides or in the spacer between the guides have also been used to provide the narrow band phase match of the two guide velocities. (See for example, R. C. Alferness, L. L. Buhl, U. Koren, B. I. Miller, M. G. Young, t. L. Koch, C. A. Burrus, G. Raybon, Broadly tunable InGaAsP/InP buried rib waveguide vertical coupler filter, Appl. Phys. Lett., Vol. 60, no. 8, pp. 980-982, 992).

Synthesis of the grating function, periodicity and changes therein in the grating coupled contra-directional coupler can be used to obtain a specified filter response. These techniques may also be modified to obtain specific filter response with the variable coupling co-directional coupler (See T. Li, C. Laliew, A. Gopinath, An iterative transfer matrix inverse scattering technique for synthesis of co-directional couplers and filters, IEEEJ. Quantum Electronics, vol. 38, pp. 375-379, April 2002). When realized in electro-7.

Optic material, the filter can also be tuned. The tuning range depends on the material electro-optic coefficient. Since both the desired amplitude and phase response can be obtained with the variable coupling co-directional coupler, techniques can be used to synthesize the coupling function for a dispersion compensator such as those originally designed for a grating function in the contra-directional coupler (See Eva Peral, Jose Capmany and Javier Marti “Iterative Solution to the Gel° Fand-Levitan-Marchenko Coupled Equations and Application to Synthesis of Fiber Gratings”, IEEE J. Quantum Electronics, Vol. 32 pp 2078-2084, 1996).

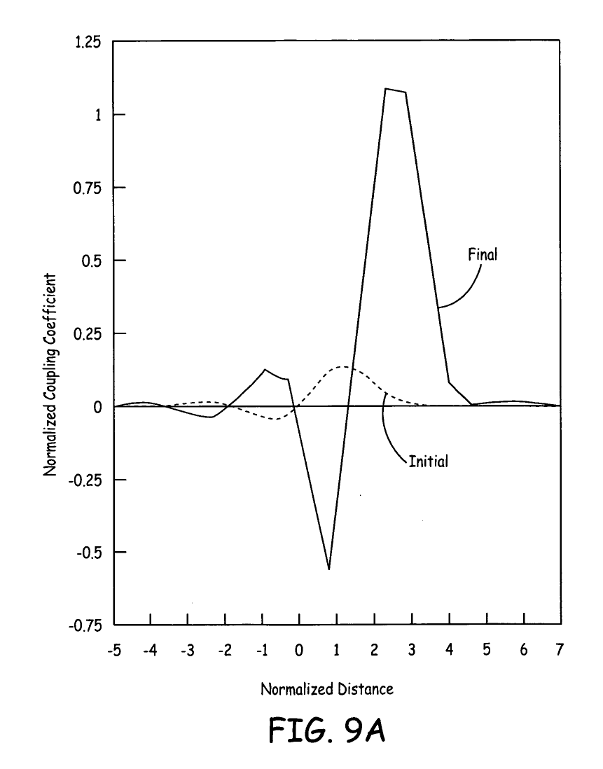

The present invention provides a co-directional coupler with variable coupling can be used as a modulator, filter, dispersion compensator, switch, with specified response functions, and similar devices. The techniques described above provide a design methodology for a co-directional coupler with variable coupling to used as an optical modulator, filter, dispersion compensator, switch with specified response, or other devices. In a specific implementation for a modulator which is designed to have a high linearity with a very low switching voltage, a trapezoidal type response may be implemented as shown in FIG. 10. While this is the ideal desired response for modulators, using the methodology discussed above, the associated coupling function is usually truncated to three or five lobes about the center. The truncated coupling function produces a response which has ripples both at the flat top region and also in the zero response region.

To obtain reasonable switching voltages for the modulator, the guides should be parallel to each other and partitioned in the positive and negative coupling regions. Between these partitions, the spatially variable coupling function needs to change sign.

A coupling sign change can be implemented in optical waveguides by introducing curved sections between the partitions as discussed above. These curved sections increase the gap between the waveguides to provide negligible coupling. A 180° phase shift length can be included in one of the sides of this curved section which are shown in FIGS. 5 and 6. The variable coupling functions derived from these designs or other techniques, are real but have both positive and negative values and may be realized in any implementation by including an additional half wavelength in one arm of the appropriate section of the coupler to achieve the desired phase shift. The variation of coupling (either positive or negative) may be implemented by adding or re-moving the material between the guides, in a manner calibrated to obtain the designed coupling variation. In most material, this would take the form of smoothly varying the etch depth between the ridge guides shown in FIG. 7 to obtain the appropriate coupling variation. The above synthesis techniques may be used to build filters with specific response functions, both amplitude and phase, which in turn can provide in dispersion compensators, and other devices.

The present invention provides a structure extending between first and second elongate optical waveguides to achieve the variable coupling. The variation of coupling (either positive or negative) may take the form of a third guide between the main guides of the coupler. This third guide is designed such that it does not propagate a signal on its own. This implies that it is cutoff at the relevant wavelengths of operation and has a width and a distance from the main guides that determines the coupling. In this context, cutoff implies that this guide would not on its own be able to support a single mode at the appropriate wavelengths, in the Transverse Electric (TE) mode or the Transverse Magnetic (TM) mode.

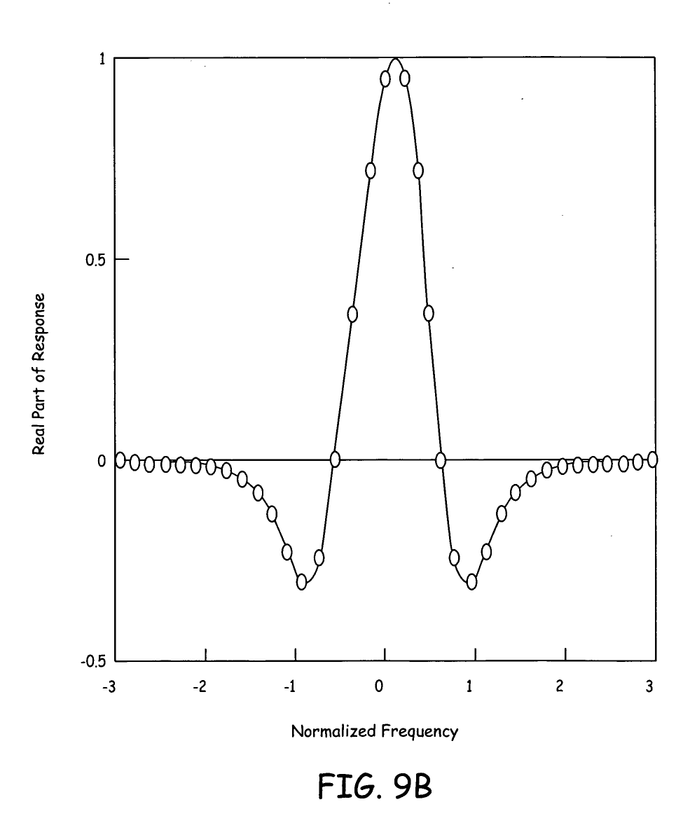

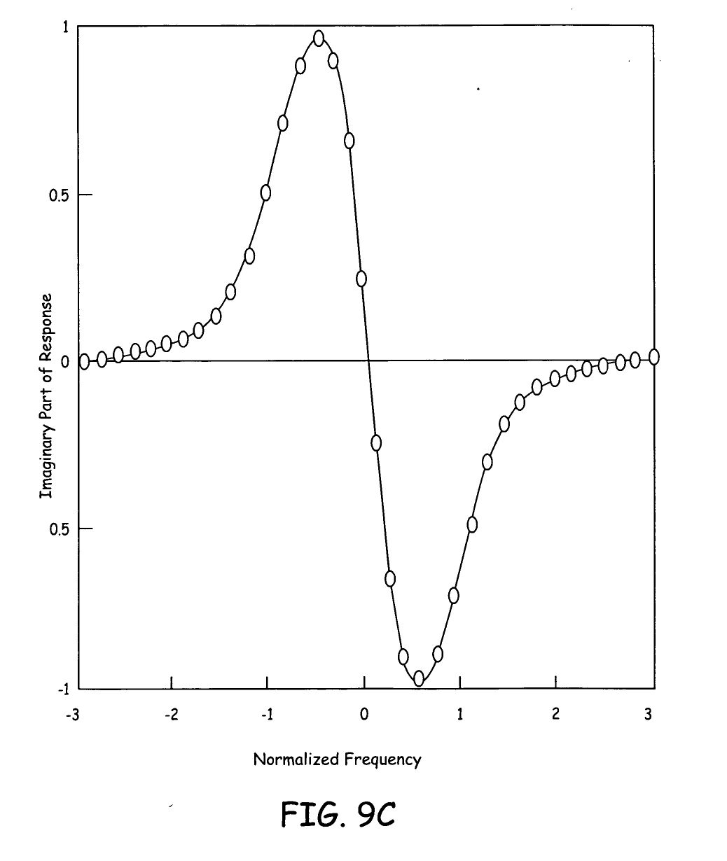

The third guide coupling in many materials may take the form a third ridge guide between two ridge guides as shown in FIG. 11. FIG. 11 is a perspective view of a variable coupler 298 which is similar to the structure shown in FIG. 2. However, in the embodiment of FIG. 11, a third ridge or waveguide 300 provides a structure which extends between waveguides 102 and 108. In the case of lithium niobate and lithium tantalate and other ferroelectric materials, this may also take the form of the third guide, which is also cutoff. Since the guides are usually formed by either Ti diffusion or proton exchange in this material, either of these techniques may be used to form this third guide. FIG. 12 is a cross-sectional view of such an embodiment in which a variable optical coupler 318 is formed on a substrate 320. First and second waveguides 322 and 324, respectively are formed by material diffused into the substrate 320. An overlying insulating layer 326 separates electrodes 328 and 330 from waveguides 322 and 324. In one embodiment, insulating layer 326 can comprise SiO₂ film between the guide and the metal contacts. A third waveguide 332 provides a structure which extends between waveguides 322 and 324 to thereby provide the variable optical coupling. Another alternative is to produce ridges over the diffused. The third guide can also be obtained by etching the lithium niobate. However, etching lithium niobate can be problematic.

The desired modulator response of the variable coupling directional coupler may also be obtained with a single coupling value, with only sign changes along the length of the modulator. In designing this structure, the coupling value and the various lengths between the sign changes may be obtained using the Fourier transform method followed by iterations in order to obtain the desired response. However, other techniques may also be used. The required coupling may be obtained by etching between the guides in semiconductor and polymer structures, by controlling the distance between the guides and semiconductors, polymer, lithium niobate structures, and other electro-optic materials. A sign change between sections can be obtained, for example, by introducing a section having an additional half wavelength in one of the arms of the coupler at the required point.

The required filter amplitude and phase response of the variable coupling directional coupler may also be obtained with a single coupling value and with only sign changes along the length of the filter. In the design of this structure, the coupling value and the various lengths between the sign changes can be obtained using the Fourier transform method followed by iterations to obtain the required response, or by other appropriate techniques. The sign change between sections can be obtained by introducing an additional half wavelength section in one of the arms of the coupler at the required point.

The present invention features a novel variable coupling directional coupler modulator and switch device in which the design of the coupler structure is synthesized to obtain a specified response function. The directional coupler modulator device is designed and fabricated using the newly available, high performance Stoichiometric Lithium Niobate (SLN) electro-optic substrate. The main feature of this device is that any response function, amplitude and phase may be obtained from the synthesized design. When the response function takes the form of a trapezoid and a DC bias used, a switching voltage of less than 1 Volt can be achieved. The linearity, defined by the two-tone test and the noise floor, has a spurious free dynamic range (SFDR) better than 130 dB. Furthermore, new periodic segmented waveguide structure designs improve the optical coupling efficiency between the optical fibers and the optical waveguides in the modulator device. The modulation efficiency for a fiber-coupled external modulator, Sₑₓₜ, defined to be the slope of the transfer curve normalized with respect to input optical power is greater than 0.75 per Volt.

The specifications for the modulator are: 1) Sₑₓₜ>0.75 per Volt; 2) switching voltage, V_{sw}<1 Volt; 3) optical device loss including fiber-waveguide interfaces <3 dB; 4) SFDR>130 dB in 1-Hz bandwidth; and 5) bandwidth 2-20 GHz. The key features of the invention include: 1) a novel directional coupler modulator design in which the coupling coefficient is varied along the light propagation direction; 2) an innovative method to increase or decrease the coupling coefficient, 3) the use of SLN material that offers increased electro-optic efficiency and new capabilities in device fabrication technologies; 4) titanium diffused waveguide process in a domain engineered SLN substrate; and 5) periodic segmented waveguide structures to increase coupling efficiency between optical fibers and waveguides in lithium niobate.

One of the greatest performance challenges for microwave photonic links is their inability to achieve high dynamic range. For the purposes here, the upper limit of dynamic range is defined by the appearance of the third-order intermodulation product (IP3) above the noise floor. The difference between the maximum modulation tone and its IP3 is defined as the dynamic range.

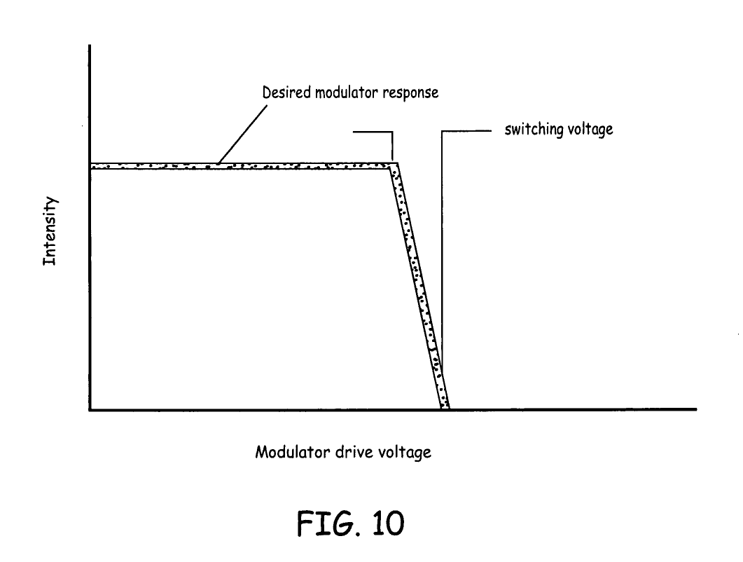

One type of commercially popular external modulator is based on Mach-Zehnder Interferometers (MZI) built using electro-optic substrates. Unfortunately, while such modulators can be designed with low V_{π} (the voltage to produce π radians phase shift), the top end of the dynamic range is severely limited by the intrinsic nature of the cosine-squared interference characteristic. FIG. 13a. is a schematic representation of the conventional directional coupler modulator 350 and FIG. 13b is a cross sectional view of the directional coupler modulator 350 taken along the line 13b-13b of FIG. 13a.

The conventional directional coupler modulator 350 and the Y-coupler modulator have two optical titanium diffused waveguides 352 and 354. The coupler 350 also includes a metal ground plate 356, a hot electrode 358 and a ground electrode 360. The hot electrode 358 respectively separated from the metal ground plate 356 and the ground electrode 360 by gaps 362 and 364. The waveguides 352 and 354 are formed in a Lithium Niobate substrate 366 and are separated from the ground plate 356, the hot electrode 358, and the ground electrode 360 by a buffer layer 368 of SiO₂.

The waveguides 352 and 354 are placed in close proximity to each other so that the gap 364 between them is constant. The coupled waveguides 352 and 354 are designed to support only one odd and one even super mode at the wavelength of operation. The constant gap 366 and the resultant constant coupling design result in a highly nonlinear sinc intensity response.

Work with extended dynamic range has shown that modulated directional couplers are amenable to linearization by modifying the coupling coefficient along the coupling length. By modifying the waveguide parameters such as the width, the core or the cladding index, the coupling coefficient can be made a function of the length of the coupling region. This modification follows the inverse Fourier transform of the transfer response. The end result is that the linear part of the transfer slope is extended to occupy more of the dynamic range.

In grating-assisted contra-directional couplers and filters, the grating design may be synthesized by the inverse scattering technique based on the theory of Gel'fand, Levitan, and Marchenko (referred to as the GLM method). This technique requires that the response function be expressed as a rational polynomial and has resulted in designs based on the usual Butterworth, Chebyschev polynomials. Further work has shown that the response functions that cannot be represented by rational polynomials may also be synthesized with this technique using the inverse Fourier transform method to obtain the first guess; and subsequently, an iterative method is used to obtain the required grating design.

An alternative is the inverse Fourier transform method, which assumes that the coupling is very small, and thus, the method is at best approximate. More detailed designs for a grating coupled filter based on the Fourier transform method can also be used. For the co-directional coupler with constant coupling, the coupling function is a rectangular pulse, and the spatial Fourier transform is the sinc function, which is the response of the output field. Thus, the intensity response has the sinc² form, and the coupling and response functions are related through the Fourier and inverse Fourier transform. Thus, if the desired intensity response function is known, the coupling function may be derived from the inverse Fourier transform. Since the Fourier technique is approximate, a Newton's method modification obtains the coupling function from the desired response function without the small coupling limitation. These design methods have been applied to demonstrate a directional coupler modulator having variable coupling in a semiconducting gallium arsenide substrate.

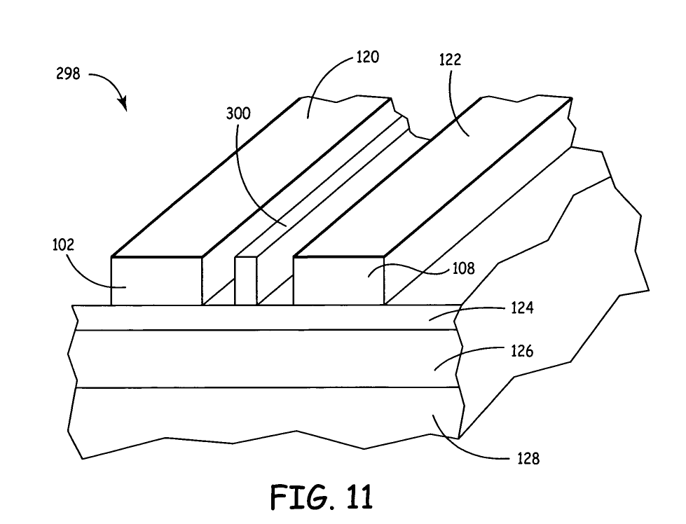

A modulator designed with a Sₑₓₜ greater than 0.75 per Volt and linearity defined by the spurious free dynamic range of greater than 130 dB in a 1-Hz bandwidth centered at 10 GHz with a potential to operate over wider bandwidth and at higher frequencies (nominally 2-20 GHz) is shown in FIG. 14. The desired response of the modulator as shown in FIG. 14 is and, with DC bias to the edge of the flat section, it gives a small switch voltage, even though the device V₀ is much larger. Having a linear drop off section, linearity is guaranteed. Hence, biasing the device at the midpoint in this region yields a high linearity spur free dynamic range.

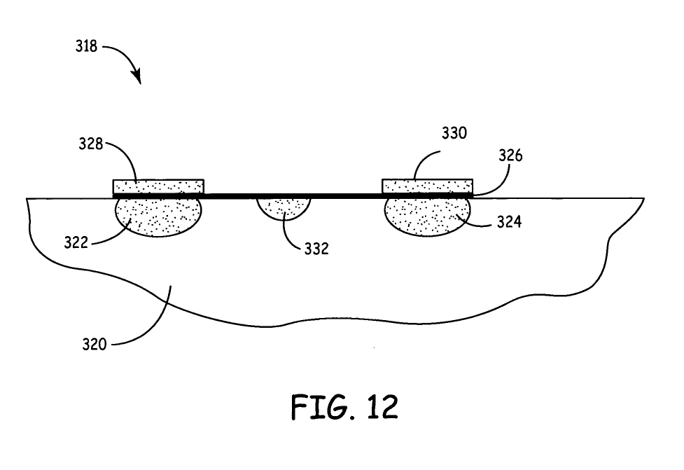

Design simulations have shown that the flat top of the trapezoid has ripples and becomes very close to a high order Chebyschev design based on the GLM method. FIG. 15 shows a seventh order Chebychev response with corresponding coupling function. As the truncation of the coupling function decreases, the slope of the fall off region also decreases. If the flat top is preserved, then the response becomes similar to the Butterworth filter with a slow fall off, which is not desirable. To overcome this deficiency, the GLM or Newton's method design methodology may be used. The Newton's method is preferred favored as it provides additional design flexibility.

Such a directional coupler modulator device is fabricated in electro-optic substrates such as lithium niobate, electro-optic polymers and semiconducting GaAs or InP. Lithium Niobate, especially the newly developed stoichiometric lithium niobate, is an ideal substrate material to realize a linearized directional coupler modulator as SLN offers additional benefits to the design, fabrication and performance of the linearized optical modulator device.

Important design features of a high linearity modulator are a variable coupling function and the achievement of a negative coupling coefficient. The present invention has the advantage that these design features are much more easily fabricated in lithium niobate and stoichiometric lithium niobate as compared to the electro-optic polymers and compound semiconductors.

The coupling coefficient between the two parallel waveguide channels is varied along the length of the device to achieve the highest linearity over the device operating range. The strength of the coupling coefficient is varied by introducing additional diffusion in close proximity to the waveguides. The additional diffusion may be done using the conventional Ti diffusion or the proton exchange process in lithium niobate. Both of these processes are used with lithium niobate to produce commercial waveguide products.

Achieving variable coupling is more complicated in electro-optic polymers and compound semiconductors. One approach is to etch the material between the two waveguides of the coupler. The trench could be a simple air gap or it can be filled with an optical material. The complexity arises in the requirement to create a trench of varying depth along the length of the device. In addition, the sidewall quality of etch influences the light transmission property in the device. Creating a variable coupling coefficient in LN or SLN by Ti-diffusion or proton exchange is an inherently low optical loss technique.

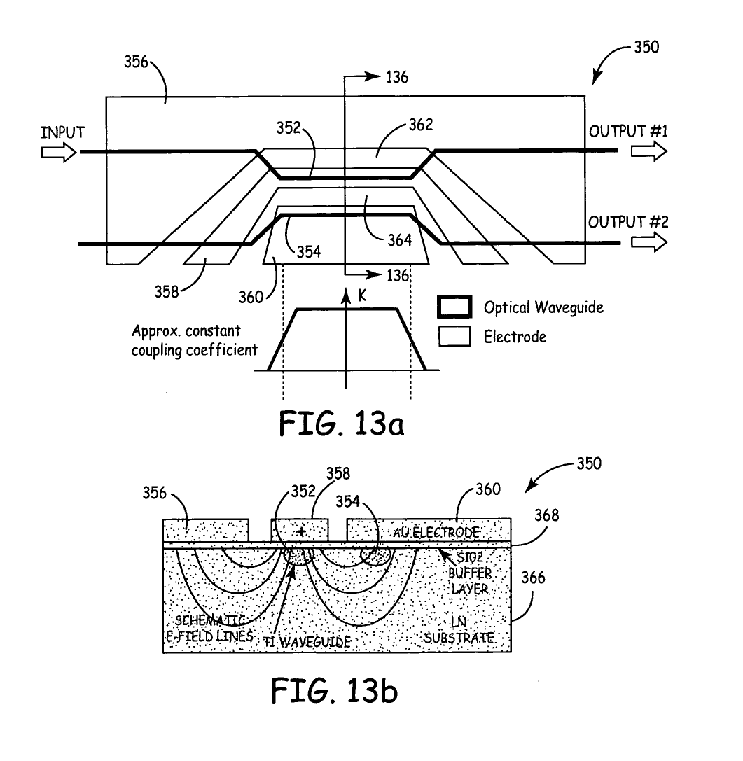

FIG. 16 is a schematic diagram of a directional coupler modulator device 400 according to the present invention. The device 400 includes a pair of waveguides 402 and 404 formed in an electro-optic stoichiometric lithium niobate substrate. The device 400 also includes a ground plate 406, a hot electrode 408 and a ground electrode 410, which are separated from the substrate in which the waveguides 402 and 404 are formed by a suitable insulator, such as SiO₂.

The waveguides 402 and 404 each include an input waveguide channel and an output waveguide channel. The input and output waveguide channels are separated from each other by approximately 250 microns for convenience of attaching to 125-micron diameter optical fibers. The separation of the waveguides 402 and 404 is gradually reduced to a gap 411 of about 7 microns at the coupling region 412.

The coupling coefficient in the center section 414 of the coupling region 412 can be increased by increasing the cladding index between the two waveguides 402 and 404. The coupling coefficient can be reduced at the end sections 416 and 418 of the coupling region 412 by increasing the cladding index on the outside sections 420, 421, 422, and 423 of the two waveguides 402 and 404. The coupling coefficient can be reversed in the intermediate sections of the coupling region 412 by introducing an extra half-wavelength at the center wavelength on one side of the coupler arms at the appropriate point to obtain the required 180° phase shift.

Continuous changes in coupling coefficient magnitude are accomplished using refractive index modifications near the waveguides 402 and 404 in the coupling region 406.

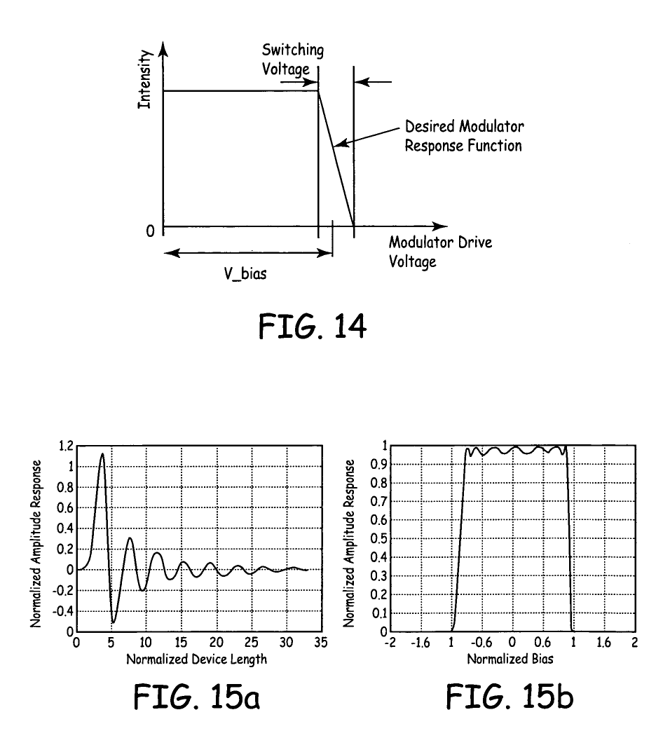

FIGS. 17a-c show Beam Propagation Method (BPM) simulations that demonstrate the effect in a lithium niobate directional coupler device, such as device 400 shown in FIG. 16, in which the waveguides 402 and 404 are 7-micron wide waveguides separated by 7 microns at the gap 411 of the coupling region 412. The simulation does not show the effect of applying a DC voltage. The refractive index of the substrate is 2.14 and the waveguide core refractive index is 2.142. The simulation in FIG. 17a shows light entering the waveguide channel on the left and transferring energy back and forth between the two waveguide channels. FIG. 17b shows the baseline coupler with coupling length 13.0 mm. The simulations in FIGS. 17a and 17c show 9.2 mm and 17.0 mm coupling lengths, respectively.

Increases to the cladding index in the coupling region 412 are accomplished by adding low-delta regions 424. Thus, an increase in the coupling coefficient in the center section 414 of the coupling region 412 is accomplished through an increase in the cladding index caused by the low-delta region 424 between the two waveguides 402 and 404. Similarly, the coupling coefficient is reduced at the end sections 416 and 418 of the coupling region 412 by increasing the cladding index through the addition of the low-delta regions 424 at the outside sections 420 and 422 of the waveguides 402 and 404.

The starting value of the coupling coefficient, for the basic coupler design, is determined on the basis of the largest change possible in the coupling coefficient while still maintaining the desired properties of the directional coupler 400. At the ends of the device 400, where the coupling coefficient must vanish, the waveguide spacing is increased as in the standard coupler design. The BPM simulations of FIGS. 17a-c show that a factor of two variation in the coupling length is easily achievable without introducing additional modes into the structure.

Two options are available for fabricating the low-delta coupling-enhancement regions 424 near the waveguides 402 and 404: additional Ti-diffused regions; and proton-exchange regions. Creating the low-index structures 424 using Ti-diffused regions allows use of a single diffusion process for fabrication of all waveguide structures. The most direct way to produce the sections 416 with different index deltas is to start with different Ti thicknesses. This requires additional photomask design, lithography and deposition steps.

A simpler, lower-cost approach for producing two different deltas for the waveguide and the coupling structures uses the same Ti thickness and, thus, requires only a single Ti mask. The method involves the use of small Ti area coverage for imparting a smaller but still uniform index delta using the same Ti thickness and processing parameters optimized for waveguide production. The lengthscale of the low-coverage Ti features should be kept below the lateral diffusion length.

The second option for creating low-delta coupling-enhancement regions or phase shift sections is through the use of a proton-exchange process instead of the traditional Ti-diffusion. This low-temperature process is capable of producing the desired regions 424 adjacent to the waveguide. However, it also requires a second photomask and additional processing steps.

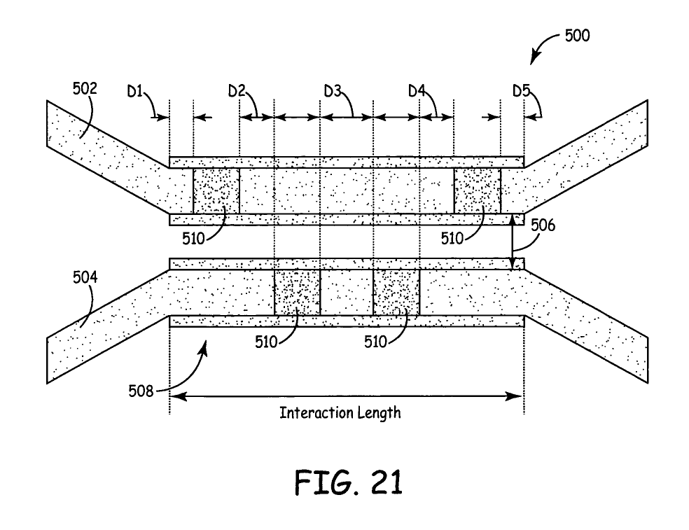

FIG. 21 is a schematic diagram of a coupler 500 in accordance with one embodiment of the invention, in which phase shifts of 180° are implemented in each waveguide 502 and 504. One embodiment of the coupler 500 includes a constant gap 506 between the waveguides 502 and 504 and a constant coupling coefficient in the coupling region 508. A pair of phase shift sections 510 are formed in each of the waveguides 502 and 504. In accordance with one embodiment of the invention, the phase shift sections 510 are proton-exchange (PE) overlays on the Ti diffused waveguide in a lithium niobate or a stoichiometric lithium niobate (discussed below) substrate 512.

In accordance with one embodiment of the invention, each phase shift section 510 provides a 180° phase shift thereby reversing the sign of the coupling coefficient. In the exemplary linear directional coupler modulator 500 of FIG. 21, the distances D1 and D5 are 664.5 micrometers, the lengths L of the phase shift sections 510 are 660 micrometers, the distances D2 and D4 are 1675.5 micrometers, the distance D3 is 15362.6 micrometers, the interaction length is 23.4 millimeters, and the distance of the gap 506 is 7 micrometers.

The differential effective index for each phase shift segment 510, Δn_{eff}, is the quantity of interest, because it determines the net phase shift Δø of the phase shift segment, which is provided by:
Δø=LΔβ=kLΔn_{eff},
where Δβ is the difference in the effective indices between the PE+Ti and the Ti waveguide regions, and L is the length of the phase shift section 510.

The proton exchange and Ti diffusion steps each increase the refractive index of the substrate 512, and the two processes tend to have an additive effect:
Δn(x,y)≅Δn_{Ti} (x,y)+Δn_{PE}(x,y).
This means that a small section of Ti waveguide that has a proton exchange overlay 510 will have a larger (extraordinary) index delta than the rest of the Ti waveguide. Only the extraordinary index is of interest here since the device is designed for operation using the TM (transverse magnetic) polarized light. While the extraordinary index is increased by the proton exchange overlay 510, the ordinary index is actually depressed by the proton exchange overlay 510.
The propagation constant fundamental TM mode, denoted by β, is found by solving for the fundamental mode of the waveguide with index change due to Ti diffusion only. The relationship between the index change and β is as follows:
Δn_{Ti}→β
Similarly, the waveguide with total index change Δn gives rise to a TM fundamental mode with propagation constant β′:
Δn→β′.
The incremental propagation constant is given by
β′=β+Δβ.
This in turn leads to a larger effective propagation constant, and a phase shift of the propagating mode relative to the unmodified Ti waveguide section, as given by

$${n}_{eff}^{′} = \frac{{β}^{′}}{k} = \frac{β + Δβ}{k} = {n}_{eff} + Δ {n}_{eff} .$$

Stoichiometric lithium niobate (SLN) is a newly developed high performance electro-optical material that offers significant benefits over congruent lithium niobate. In fact, as shown in Table 1 below, stoichiometric lithium niobate is superior to congruent lithium niobate in every aspect of its material characteristics. SLN offers increased electro-optic coefficient, higher optical power handling capability, lower coercive field, higher Curie temperature, optical transparency over a larger wavelength range, and lower defects than CLN.

Commercially made lithium niobate modulator devices have been based on congruent lithium niobate (CLN) with composition CLi=[Li]/([Li]+[Nb])=48.4%. While the CLN has been successfully employed in many devices, several deleterious materials properties related to its nonstoichiometric composition have limited its use in many demanding applications. The higher electro-optic coefficients for SLN significantly reduce the demands on electro-optic device drive electronics contributing to smaller packages, lower weight, and reduced power consumption. The higher Curie temperature of SLN aids in the fabrication of Ti in-diffused waveguides. And, the lower defect density of SLN enhances the damage resistance when operating in very high power optical applications or in high radiation environments.

In a direct comparison of the electro-optic effect in CLN and SLN, the value of the electro-optic coefficient r₃₃ has been measured to be over 20% greater for SLN than CLN. The r₂₂ coefficient in SLN has been observed to initially decrease to one half that of CLN as the Li concentration is increased from the congruent composition of CLi=48.4% to CLi=48.9%. The r₂₂ coefficient in SLN is then observed to increase to nearly double that of CLN as the composition continues to increase from CLi=48.9% and approaches the stoichiometric limit CLi=50% of SLN. This initial decrease followed by a substantial increase in r₂₂ has been computationally validated using molecular dynamics cluster optimization calculations. No similar computational calculation has been reported for electro-optic coefficients other than r₂₂, but similar behavior would explain wide differences reported for the various electro-optic coefficients as the composition of crystals varies.

TABLE 1
Comparison of Material Characteristics of
CLN and SLN

| Parameter | CLN | SLN |
|---|---|---|
| Molecular ratio | 48.5:51.5 | 49.9:50.1 |
| (Li₂O:Nb₂O₅) | | |
| Electro-optic coefficient | 30.8 pm/Volt | 38.3 pm/Volt |
| (r₃₃) | | |
| Melting point | 1260 C. | 1180 C. |
| Curie temperature | 1145 C. | 1200 C. |
| Optical transparency | 325-5500 nm | 305-5500 nm |
| Coercive field | 22 kV/mm | <4 kV/mm |
| Optical power handling | ˜1 MW/cm² (5% | >2 MW/cm² (1% |
| capability | MgO) | MgO) |

The preferred method of fabricating the waveguide channels in congruent lithium niobate is by high temperature titanium (Ti) diffusion at about 1000 C. The temperature at which Ti diffusion takes place is typically very near the ferroelectric Curie temperature, which can sometimes lead to depoling of the crystal, thus, severely deteriorating device performance. Moreover, the diffusion of Ti reduces the Curie temperature of the material leading to increased risk of generally unwanted domain inversions in the Ti diffused waveguide region.

One method of overcoming this problem is to fabricate the waveguide 400 using the proton-exchange (PE) process, which is carried out at a relatively low temperature of 350 C. The proton-exchange waveguides are not desirable because they lead to instability in device performance. Commercial optical modulator devices manufactured using CLN have not been able to benefit from the improved performance offered by the combination of domain engineering and Ti diffused waveguide because of the complexity and the additional cost associated with the increased process steps.

Stoichiometric lithium niobate enables the use of the commercially practiced high temperature diffusion of titanium to fabricate efficient optical modulator devices in domain-engineered substrates because of the increased Curie temperature of SLN. The Curie temperature of stoichiometric lithium niobate is 55 C higher than for CLN, even higher than the melting point of the SLN material itself (see Table 1). Since the diffusion temperature is well below the Curie point of the SLN crystal, there is very little risk of any depoling of the SLN crystal during the high temperature Ti diffusion process. The efficient modulator device design combining domain engineering and Ti diffusion can now be practiced in SLN without resorting to the additional process steps and manufacturing costs compared to CLN.

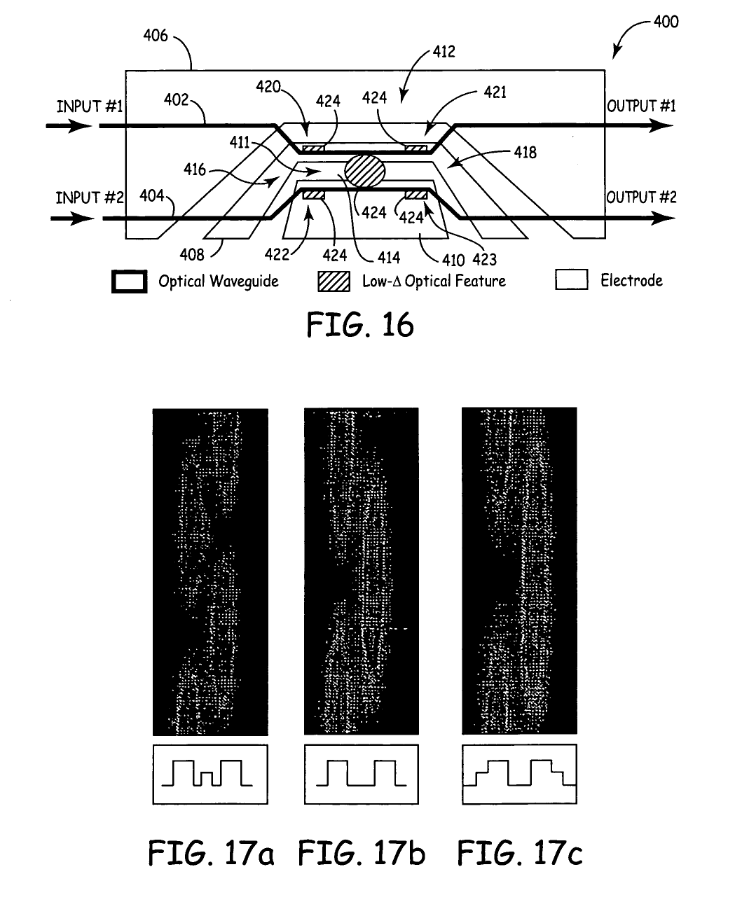

Domain engineering in SLN produces electrode structures that offer efficient electro-optic interaction between the RF signal and the optical wave. FIG. 18 shows a device 400 that includes a single hot electrode 408 that covers both the top and bottom waveguides 402 and 404. This design offers lower RF signal loss, lower switching voltage and improved velocity matching between the RF and the optical waves than the narrow hot electrode 408 shown in FIGS. 13a-b and 16. The hot electrode 408 of the device 400 in FIG. 18 covers both waveguide channels of the coupler, and is about 4 times as wide as the designs of FIGS. 13a-b and 16. This reduces the RF signal loss by a factor of 4 and, thus, increases the bandwidth also by a factor of 4.

Commercially available optical modulators have an optical fiber-to-fiber loss of about 4-5 dB. The total loss is the sum of the optical interface loss at the optical fiber-waveguide interfaces and the optical waveguide loss in the lithium niobate substrate. The Ti diffused optical waveguide, which has an optical loss of only about 0.1 dB/cm, contributes a total loss of about 0.5 dB for a typical 5 cm long modulator device. The major loss occurs at the fiber-waveguide interfaces, each interface contributing about 1.5-2 dB optical loss. This high loss occurs because of a large mismatch between the optical fiber mode size and the optical waveguide mode size. The optical fiber has a circular mode field diameter of about 10 microns, and the optical waveguide has an elliptical mode field diameter of 3×5 microns.

A small mode size is desirable for the optical waveguide modulator to maximize the overlap between the optical and the electrical fields. It has been shown that the Vₚᵢ-L product decreases with decreasing mode size. Unfortunately, a small mode size introduces a large loss at the fiber-waveguide interface. This problem can be solved by introducing a mode transformer at the input and output optical fiber-waveguide interface. The mode transformer gradually changes the mode field diameter of the light beam propagating in the waveguide to match the mode field of the optical fiber. Thus, the optical device is simultaneously optimized for the highest optical coupling and electro-optic modulation efficiencies.

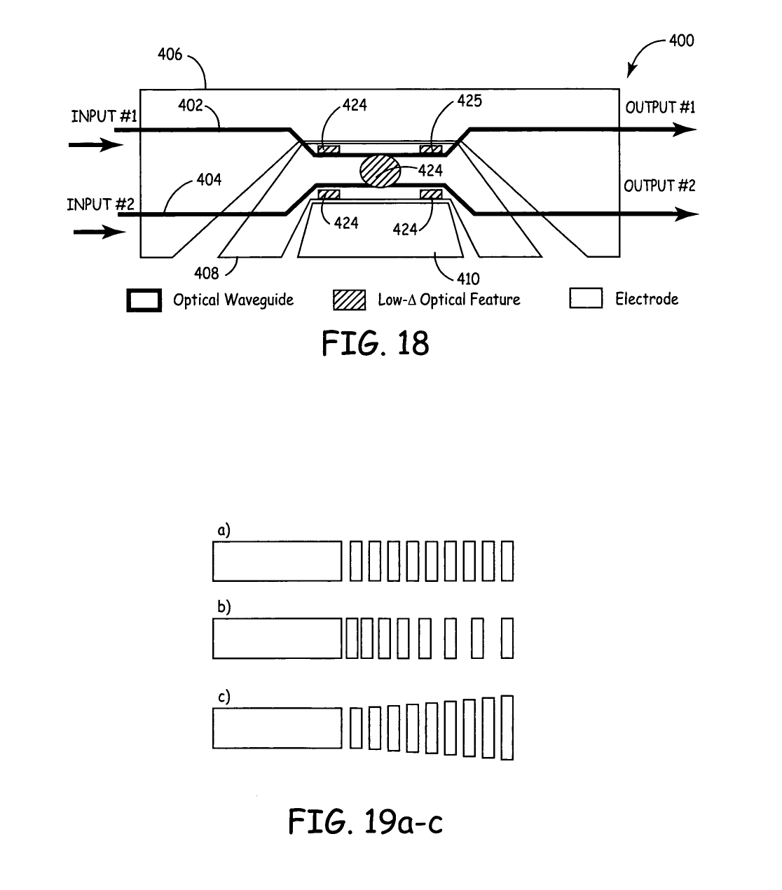

One such mode transformer is a periodic segmented waveguide (PSW). PSW structures, as shown in FIGS. 19a-c, expand the mode field size in the waveguide by decreasing the effective index of the waveguide to better match the mode field diameter of the optical fiber. The optical mode field expands as the wave travels from left to right and vice versa. PSWs are preferred over adiabatic tapers because they expand the beam not only in the plane but also normal to the plane.

The schematic shown in FIGS. 19a-c represents areas of high index regions produced in the substrate. In the simplest case of a uniform PSW with period Λ, spaces of width Γ, and the same index change Δn as the rest of the waveguide, it has been shown that the PSW section acts as a waveguide with effective index Δn′ that is simply weighted by the duty cycle:
Δn′=Δn(1-Γ/Λ)

The mode size of the optical waveguide may be tailored in the plane and in the depth using a tapered periodically segmented waveguide. The PSW in FIG. 19a introduces a sudden increase in effective index, whereas the PSW in FIG. 19b makes a gradual change. The structure shown in FIG. 19c provides additional mode expansion in the horizontal plane. All structures are shown with very few periods for simplicity. The optical fiber-waveguide interface loss may be reduced to less than 1 dB per interface using the technique in Ti:LN waveguide devices.

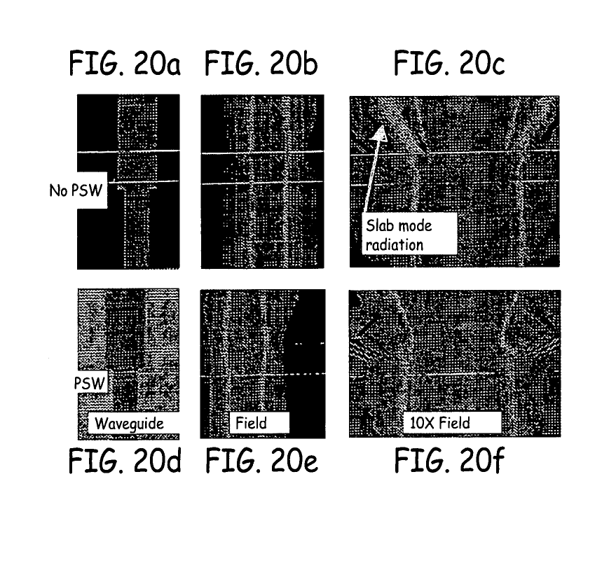

The results of Beam Propagation Method (BPM) simulations shown in FIGS. 20a-c demonstrate the benefit of using PSW structures to improve the light coupling efficiency between the two waveguides. In practice, more periods are used than have been illustrated. FIG. 20a shows an abrupt junction between two step-index waveguides while FIG. 20d incorporates a PSW structure to transition between the two step-index waveguides. The optical field patterns are shown in FIGS. 20b, 20e and 20c, 20f (10×). The PSW structure reduces the radiation loss and thus increases the coupling of light between the two guides.

The present invention includes a new way to customize a wide range of optical communications devices. These devices are all based on the optical directional coupler, and include optical switches, filters, modulators, polarization converters, and others. Active or passive devices can be customized with the techniques of the present invention.

The directional coupler 400, embodiments of which are shown in FIGS. 16 and 18, includes two optical waveguides 402 and 404 (such as fiber optic cables) placed very close together. The waveguides can be diffused waveguides in Lithium Niobate (LiNbO₃). When placed in such close proximity to each other at a coupling region 412, the light in one waveguide transfers to the other as it travels. This property makes the coupler a fundamental device for used in a wide range of devices, such as those listed above.

One aspect of the invention includes the discovery that by shifting the phase of the light in one waveguide relative to the other, by different amounts and at different points along the device, it is possible to alter significantly how the coupler works. This allows devices based on the directional coupler of the present invention to be customized for different applications.

The present invention provides methods and devices for implementing the phase shift in the directional coupler. In accordance with one embodiment of the invention, the phase of the light in one waveguide is changed relative to light in the other waveguide by forming “phase shift sections” in the coupler where the refractive indices of the two waveguides are different. This causes light in one waveguide of the coupler 400 to travel faster than light in the other waveguide, so at the end of each phase shift section, the phase difference between the light in the two waveguides has been shifted. This allows for customized optical devices for a wide range of applications to be made, simply by placing the phase shift sections at the proper locations of the directional coupler.

The techniques of present invention can be used to customize optical switches, filters, modulators, polarization converters, and other devices. Any material system can be used to make the phase shift sections, because waveguide refractive index can be altered not only by changing the material refractive index, but also by changing the waveguide dimensions.

The present invention also allows for well-controlled phase shifts because the refractive index of the waveguides can be varied relatively accurately. For many material systems, the refractive index can be varied predictably, through diffusion of other materials, heating, or optical means. For others, the waveguide cross-section can be varied to change the refractive index.

Embodiments of the present invention also provide methods of forming phase shift sections without bending the waveguides. Waveguide bends cause light to be lost, which adversely affects how the directional coupler works, and reduces power efficiency. The technique of the present invention avoids bending the waveguide, which should greatly reduce the amount of power lost in each phase shift section.

The reduction of power loss in the phase shift sections while allowing the phase to be accurately controlled, allows directional coupler based devices to be customized more accurately than previously possible.

One aspect of the invention includes a method of varying a phase shift of a light beam as it propagates in a waveguide, using the techniques described above. Additional aspects are directed to a direction coupler device configured to implement the method.

Another aspect of the invention incudes a method of varying the coupling coefficient between waveguides that are placed in close proximity to each other, as described above. Additionally, the method can be applied to two or more waveguides. Thus embodiments of the coupler device configured to implement the method include a coupler device having two, three, or more waveguides between at least two of which the coupling coefficient is varied in accordance with the method of the present invention. In accordance with another embodiment of the device, the waveguides are oriented substantially parallel to each other.

Another aspect of the invention is directed to the modification of waveguide properties using a ridge structure, an etched structure, diffused structures, and domain inverted structures. Such structures can be used, for example, to modify the phase shifts and the coupling coefficient between the waveguides of the device. The use of domain inverted structures in lithium niobate is used in a Mach-Zehnder type device is provided in U.S. Pat. Nos. 5,267,336 and 6,600,843.

Yet another aspect of the invention is directed to a method of modifying a waveguide and the coupling coefficient between the waveguides through the deposition of material.

Still yet another aspect of the present invention is directed to a method of shaping the output response function of a coupler device. For example, embodiments of the coupler device include metal electrodes to which a voltage can be applied to affect the light exiting the coupler device. A layer of dielectric material preferably separates the substrate and the metal electrodes to buffer the waveguide from the metal surface. In accordance with one embodiment of the invention, the electrodes are surface electrodes where all of the electrode material is on the same surface as the waveguide. However, the electrodes may also be on the bottom surface of the wafer to achieve additional design flexibility.

Although the present invention has been described with reference to preferred embodiments, workers skilled in the art will recognize that changes may be made in form and detail without departing from the spirit and scope of the invention. The devices can be fabricated in any appropriate material which shows electro-optic effects including semiconductors.

1. An optical coupler, comprising:
a substrate Lithium Niobate;
a first elongate optical waveguide on the substrate;
a second elongate optical waveguide on the substrate which extends adjacent to the first elongate optical waveguide; and
a structure extending proximate the first elongate optical waveguide and the second elongate optical waveguide and configured to provide variable coupling therebetween.

2. The apparatus of claim 1 wherein the structure comprises a ridge.

3. The apparatus of claim 1 wherein the structure comprises diffused material.

4. The apparatus of claim 1 wherein the waveguides are formed in Lithium Niobate.
